(19) United States
(12) Patent Application Publication
(10) Pub. No.: US 2024/0142589 A1
(43) Pub. Date: May 2, 2024

(54) SOLID STATE LIDAR ARCHITECTURE FOR LOW-COST ALIGNMENT

(71) Applicant: Luminar Technologies, Inc., Orlando, FL (US)

(72) Inventors: Daniel Joseph KLEMME, Robbinsdale, MN (US); Daniel Aaron MOHR, St. Paul, MN (US); Aditya JAIN, Minneapolis, MN (US)

(21) Appl. No.: 18/495,632

(22) Filed: Oct. 26, 2023

Related U.S. Application Data
(60) Provisional application No. 63/381,101, filed on Oct. 26, 2022.

(51) Int. Cl. G01S 7/497; G01S 7/481

(52) U.S. Cl. CPC G01S 7/497; G01S 7/4814

(57) ABSTRACT

Implementations described and claimed herein provide an example LiDAR architecture that facilitates low-cost alignment of solid state components. The system includes at least a transceiver chip, a laser, and a u-shaped optical amplifier. The transceiver chip includes a signal preparation block that receives light from the laser and that modulates the laser light. The u-shaped optical amplifier is positioned to receive a light signal output from the signal preparation block and to output an amplified light signal back into the transceiver chip.

### CROSS-REFERENCE TO RELATED APPLICATIONS

This application is a non-provisional application based on and takes priority from pending U.S. provisional application Ser. No. 63/381,101, entitled “Solid State LiDAR Architecture for Low-Cost Alignment,” which was filed on Oct. 26, 2022. The disclosure set forth in the referenced application is incorporated herein by reference in its entirety.

### BACKGROUND

Light detection and ranging (LIDAR) is a technology that measures a distance to an object by projecting a laser toward the object and receiving the reflected laser. In various implementation of LiDAR systems, a light source illuminates a scene. The light scattered by the objects of the scene is detected by a photodetector or an array of photodetectors. By measuring the time that it takes for light to travel to the object and return from it, the distance may be calculated.

LiDAR systems typically include photonic components for creating, manipulating, or detecting light, and may also include non-photonic electrical components. While semiconductor materials can be used to form some or all of these structures, different types of semiconductor materials for optical and non-optical sources.

### SUMMARY

Implementations described and claimed herein provide a LiDAR system architecture that facilitates low-cost alignment of solid state components. The LiDAR system architecture includes a transceiver chip including a signal preparation block that modulates an outgoing light beam; a laser attached to the transceiver chip, the laser positioned to provide an input to the signal preparation block; and a u-shaped optical amplifier attached to the transceiver chip positioned to receive an optical signal output from the signal preparation block and output an amplified optical signal to the transceiver chip.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### BRIEF DESCRIPTION OF THE DRAWINGS

FIG. 1 illustrates an example LiDAR system implementing an architecture that facilitates low-cost alignment of solid state components.

FIG. 2A illustrates an example laser alignment operation performed prior to attaching a laser to a transceiver chip in LiDAR system.

FIG. 2B illustrates an example attachment operation following the alignment operation of FIG. 2A.

FIG. 3A illustrates an example amplifier alignment operation performed prior to attaching an optical amplifier to a transceiver chip in a LiDAR system.

FIG. 3B illustrates an example attachment operation following the alignment operation of FIG. 3A.

FIG. 4 illustrates an example LiDAR system with a monolithically-formed optical chip including both a laser and an optical amplifier.

FIG. 5 illustrates components of another example LiDAR system with a monolithically-formed optical chip including both a laser and a u-shaped optical amplifier with a tapered waveguide.

FIG. 6 illustrates example operations for aligning solid state components in a LiDAR system.

FIG. 7 illustrates an example processing system that may be useful in implementing the described technology.

### DETAILED DESCRIPTIONS

Semiconductor materials are each characterized by a band gap representing the minimum energy that is required to excite an electron up to a state in the conduction band where it can participate in conduction. These band gaps can be classified as either “direct-bandgaps” or “indirect-bandgaps.” Direct-bandgap semiconductors can emit light efficiently because electrons can drop directly from the conduction band to the valence band without changing their momentum, which requires interactions that can drain away energy. Therefore, direct-bandgap semiconductors are typically preferred for light-generating components such as LEDs, lasers, and optical amplifiers. At the same time, indirect-bandgap semiconductors, such as silicon, are often preferred for non-light-emitting electrical components and are widely used for electronic integrated circuits because they tend to be inexpensive and more capable of handling light power with lower absorption losses. Silicon also has high-resolution nodes available and is characterized by well-understood processes. What this means is that a typical LiDAR system may include a primary integrated circuit chip (IC) formed of indirect band gap material (e.g., crystalline silicon) and other, separately formed, optical components formed of direct bandgap semiconductor material (such as laser(s) and amplifier(s)) that are, during LiDAR system assembly, physically packaged with the primary IC in a manner that allows for efficient transmission between the primary IC and the separately-formed optical components.

When it comes to present-day silicon photonics, one of the main cost drivers of a photonic chip is actually the packaging in which lasers, amplifier, etc. are aligned to the chip and packaged together. This packaging is often an arduous manual process that must be done on each chip separately. One reason this process is arduous is that it typically entails a precise 3D alignment process to align and attach each light-emitting semiconductor component to the main electronics chip, which is separately formed due to being made out of a different type of semiconductor material (e.g., indirect bandgap instead of direct bandgap). In some systems, this alignment is facilitated using optical fibers that need to be bent in various ways with ends carefully secured to provide a connection between the separately-formed semiconductor components.

The herein disclosed technology proposes a LIDAR chip architecture that facilitates low-cost alignment of solid state optical elements. In one implementation, the architecture includes a transceiver chip and a monolithically-formed optical chip that includes an amplifier, and a laser. The transceiver chip is formed of indirect-bandgap semiconductor material(s) and includes a signal preparation block that prepares an outgoing LiDAR light signal and also a return signal processing block that performs processing on a return signal received at a detector. The monolithically formed optical chip is made of direct-bandgap materials and is aligned with and attached to the transceiver chip during a manufacturing process.

In yet another implementation, the laser and amplifier are formed separately rather than monolithic.

Due to selected processing methods in either of the above implementations, the components being attached each have precisely-controlled thicknesses and substantially planar surfaces that interface when the two chips are coupled to one another. As used herein, “substantially planar” refers to a surface that is perfectly planar to within +/−100 nanometers.

Due to the near-perfect planar nature of the planar surface on the transceiver chip and optical chip(s), optical pathways on the different components can be easily aligned without the use of fiber optic wires that must be manually aligned and secured on both ends. Instead, a machine can be programmed to automatically perform the alignment consistently and repeatedly without variation from one chip to another. This alignment process is less time consuming and lower cost than other alignment processes available in LiDAR devices with different architectures.

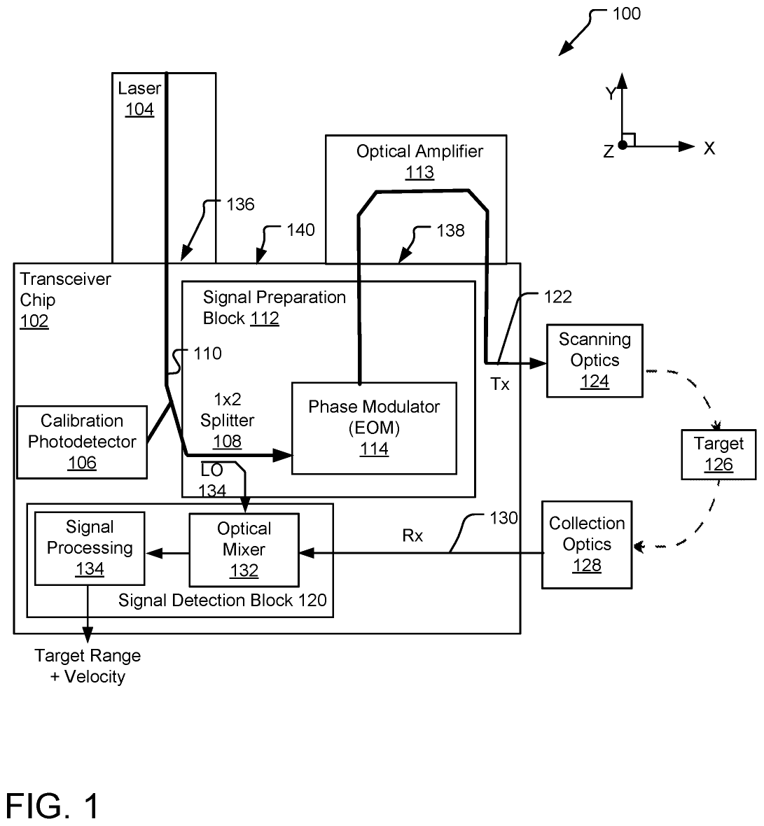

FIG. 1 illustrates an example LiDAR system 100 implementing an architecture that facilitates low-cost alignment of solid state components. The LiDAR system 100 includes a transceiver chip 102 that is formed monolithically (as a single unit), from indirect band gap materials, during a semiconductor manufacturing process. The LiDAR system 100 includes separately-formed photon-emitting components including a laser 104 and an optical amplifier 113.

Light from the laser 104 enters a top surface of the transceiver chip 102 and is directed into a waveguide 110 within a signal preparation block 112. The waveguide 110 is coupled to both a calibration photodetector 106 and also into a splitter 108. The calibration photodetector 106 is used to during a laser alignment process to maximize coupling efficiency between the laser 104 and the waveguide, discussed in greater detail below.

The splitter 108 is configured to split light it receives form the waveguide 110 into a first signal input to a phase modulator 114 and a second signal input to a local oscillator (LO) 134. The phase modulator 114 modulates the light in some way, such as by introducing a continuous frequency shift or pseudo-random binary sequence (PRBS) pattern on the phase. The resulting modulated light is then input to an optical amplifier 113. Photons in this light stimulate atoms in a gain media of the optical amplifier 113, causing electron state changes that release additional photons, increasing the optical power of the light exiting the optical amplifier 113 as compared to the light entering the optical amplifier 113. The amplified light exiting the optical amplifier 113 is directed back to a transmit arm 122 of the transceiver chip which, in turn, directs the light to scanning optics 124 that project the light onto a target 126 in a three dimensional scene surrounding the LiDAR system 100.

In some cases, light leaving the Tx arm 122 is scanned by the scanning optics 124 though an angular field, for example the angular field can correspond to a 300 field of view, a 60° field of view, or any other desired angular field of view. Light bounces off the target 126 and is collected by collection optics 128 coupled to an Rx arm 130 of the transceiver chip 102. This light is then combined, at an optical mixer 132 with the reference beam from the LO 134. Combining the scattered light collected from the target 126 with the reference beam output by the LO 134 is performed by an optical mixer 132. Output from the optical mixer 132 is then directed onto a signal processing block 112, which outputs a detected range of the target 126 and target velocity (e.g., if the target is moving).

The laser 104, optical amplifier 113 and transceiver chip 102 are all formed during semiconductor manufacturing processes. The laser 104 and optical amplifier 113 are made of direct bandgap materials, while the transceiver chip 102 is made of indirect bandgap materials. Although these three semiconductor components are separately formed, they are all manufactured using techniques that provide tight control over component thickness, such as using nanolithography techniques. Consequently, inner-facing surfaces of these components (e.g., surface 136 of the laser 104, surface 138 of the optical amplifier 113, and surface 140 of the transceiver chip 102) are all substantially planar. Due to this planarization, the surfaces 136 and 138 can be brought directly into contact with the surface 140 during a calibration alignment, facilitating a low-loss butt-coupling of the light-emitting components (e.g., the laser 104 and the optical amplifier 113) to the transceiver chip 102.

The optical amplifier 113 is, in FIG. 1, u-shaped. The optical amplifier 113 has an input and an output that are butt-coupled with the transceiver chip 102, without optical fibers connecting the two components together. The tightly controlled planarization of the abutting surfaces reduces or eliminates loss and the absence of optical fibers facilitates a low-cost alignment and assembly process that can be standardized and automated for an assembly line.

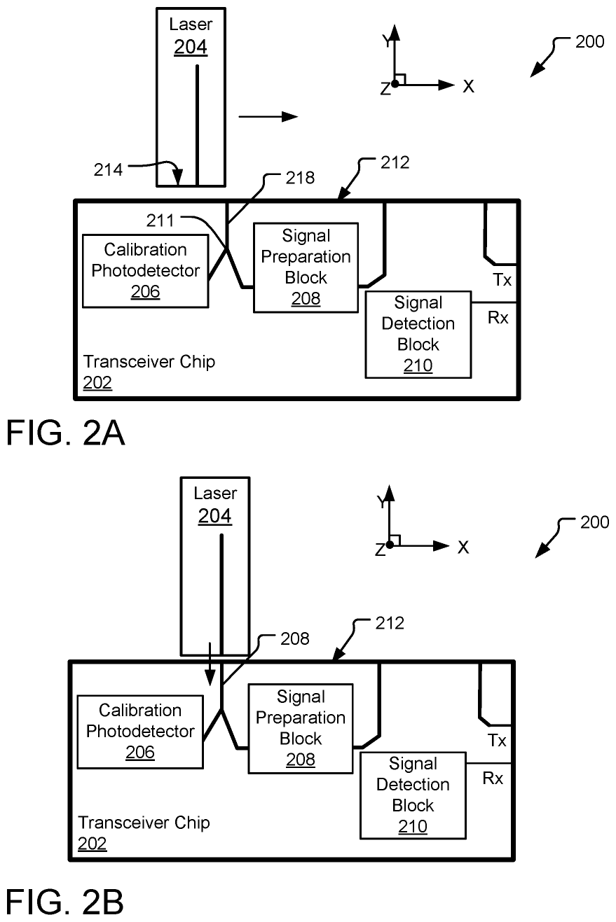

FIG. 2A illustrates an example laser alignment operation performed prior to attaching a laser to a transceiver chip in LiDAR system. The LiDAR system 200 includes a monolithically-formed transceiver chip 202 and a laser 204 that is formed separate from the transceiver chip 202. The transceiver chip 202 includes features the same or similar to those described with respect to FIG. 1 including, for example, a calibration photodetector 206, signal preparation block 208 (e.g., including a phase modulator) and a signal detection block 210 (e.g., including detection optics and signal processing components).

In FIG. 2A, a laser 204 is shown being aligned with a waveguide 218 on the transceiver chip 202. The waveguide 218 includes a splitter 211, which directs a fraction of light that enters the waveguide 218 onto the calibration photodetector 206. During a laser alignment process, the laser 204 is lowered to within a predefined y-direction separation of the transceiver chip, such as a few millimeters. While the laser 204 is fixed at this predefined y-direction separation, the laser 204 is controllably moved along first and second perpendicular axes to identify a position of maximum coupling efficiency. For example, the laser 204 is first turned on (e.g., either pulsing or emitting continuously light) and moved along the x-direction along a line passing near or over an input of the waveguide 218. During this movement, photon counts of the calibration photodetector 206 are monitored and an x-direction position of highest coupling efficiency (maximum light capture) is identified. With the laser 204 fixed at the x-direction position of highest coupling efficiency, the laser 204 is then controllably moved in the z-direction (into the page along a plane parallel to surface 212), and a z-direction position of highest coupling efficiency is next identified.

Once the X and Z positions of highest coupling efficiency are identified, the laser is attached to the transceiver chip 202 at this X/Z position of highest coupling efficiency.

FIG. 2B illustrates an example attachment operation following the alignment operation of FIG. 2A. Specifically, FIG. 2B illustrates a step of attaching the laser 204 to the transceiver chip 202 at the identified position of highest coupling efficiency. In one implementation, laser 204 is lowered from a fixed y-position at which the above-described X/Z direction calibration is performed. Once the laser 204 is in contact with the transceiver chip 202 at the identified position of highest coupling efficiency, heat is applied to melt solder balls at an interface between surfaces 212, 214.

In another implementation, the alignment calibration and attachment is performed in a flip-chip position, with the components rotated 180 degrees from that shown in FIGS. 2A and 2B (in which it can be assumed that gravity acts in the negative y-axis direction). In this case, the calibration alignment may entail the same actions as those described above with the laser 204 pointed upward to direct light into the transceiver chip 202 instead of down into the transceiver chip 202.

In yet another implementation, one of the inner-facing surfaces 212 or 214 is coated with a transparent curable paste prior to the alignment. The laser 204 is lowered into contact with the paste as shown in FIG. 2B and the paste is cured with a suitable medium, such as heat or UV light.

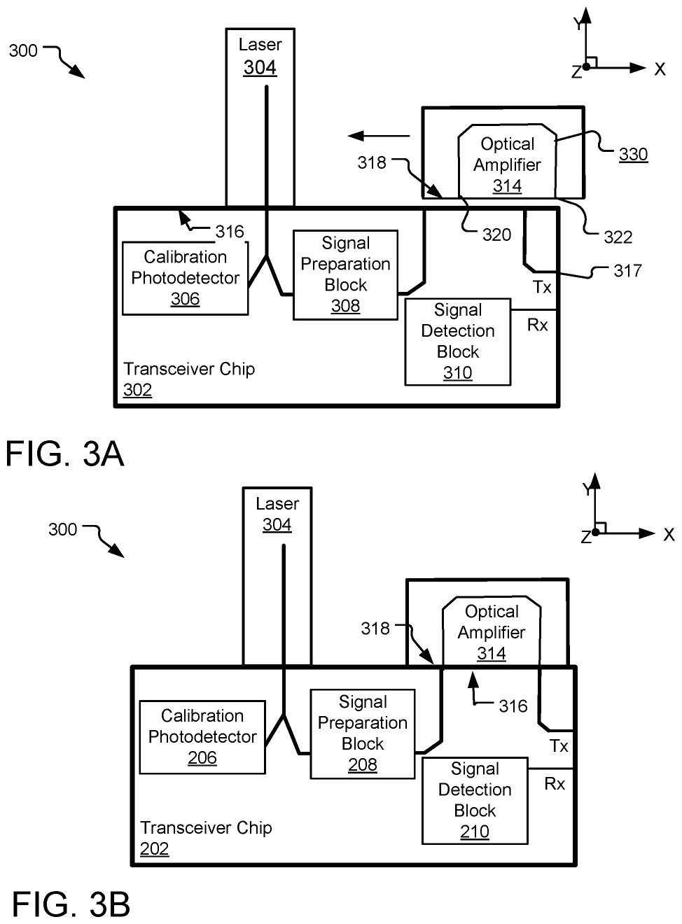

FIG. 3A illustrates an example alignment operation performed prior to attaching an optical amplifier 314 to a transceiver chip 302 in a LiDAR system. The transceiver chip 302 includes features the same or similar to those described with respect to FIG. 1-2 including, for example, a calibration photodetector 306, signal preparation block 308, and a signal detection block 310. A laser 304 has been previously attached to the transceiver chip 302, such as in a series of operations the same or similar to those described above with respect to FIG. 2A-2B.

The optical amplifier 314 is a u-shaped and includes a waveguide 330 having a single input and output, both of which are formed on surface 318 which faces surface 316 of the transceiver chip 302 when the LiDAR system 300 is fully assembled. In one implementation, the optical amplifier 314 includes a gain medium with some atoms, ions, or molecules, in an excited state which can be stimulated by received light to emit more light in the same radiation modes. In one implementation, the optical amplifier 314 comprises InP and InGasAsP layers to amplify incident light with a wavelength of 1550 nm. The size of the optical amplifier 314 may vary, but in some implementation has length and height (X, Y in FIG. 3) of approximately 2×2 mm to 4×4 mm. Depending on select characteristics of the optical amplifier 314, amplifier output may be in the range of 26 dBm to 40 dMb. To ensure light does not radiate out of the amplifier at the bends in the u-shape, these bends may roughly have a 1-2 mm turn radius.

The u-shape design of the optical amplifier 314, together with the tightly-controlled planarization of the surfaces 318, 316, and the tightly-controlled spacing between the amplifier's input 320 and output 322 and corresponding waveguide elements in the transceiver chip 302 ensures that the input 320 and the output 322 can be aligned together with the transceiver chip 302 in a same alignment step.

In one exemplary alignment process, the optical amplifier 314 is lowered to within a predefined y-direction separation of the transceiver chip 302, such as a few millimeters. With the optical amplifier 314 fixed at this predefined y-direction separation and with a transmission arm 317 is fixed of the transceiver chip 302 pointed at a stationary target, the laser 304 is turned on. With the transceiver chip 302 fixed in position and pointing at the stationary target, the optical amplifier 314 is controllably moved in the X and Z directions while a machine or human operator monitors intensity of a light signal detected by a detector (not shown) within the signal detection block 310.

The alignment of the optical amplifier 314 to corresponding waveguides within the transceiver chip 302 may either be performed step-wise in two dimensions (e.g., by moving the optical amplifier 314 in small, alternating increments of X and Z), or in one dimension at a time, such as by first moving in X to identify the best X-position and then repeating for Z, until an [X, Z] position of maximum coupling efficiency is identified.

Once the [X, Z] position of maximum coupling efficiency is identified, the optical amplifier 314 is attached to the transceiver chip 302 such as by melting solder (either in an upright or opposite flip-chip position) or by applying heat or UV light to cure a transparent adhesive applied to one of inner facing surface 316, 318, such in the same or similar manner as that described with respect to FIGS. 2A and 2B.

Notably, the u-shaped design of the optical amplifier 314 allows for amplified light to be received by the transceiver chip 302 without the use of an intermediary component, such as an optical fiber, to receive amplifier output and direct the amplified light output back down into the transceiver chip 302. The elimination of this intermediary component reduces or eliminates losses that may otherwise result from imperfect couplings with endpoints of the intermediary component and greatly simplifies the alignment and attachment process illustrated in FIG. 3A through 3B, allowing the process to be standardized and automated.

FIG. 3B illustrates an example attachment operation following the alignment operation of FIG. 3A. In this figure, the optical amplifier 314 is shown aligned and attached to the transceiver chip 302, as described above.

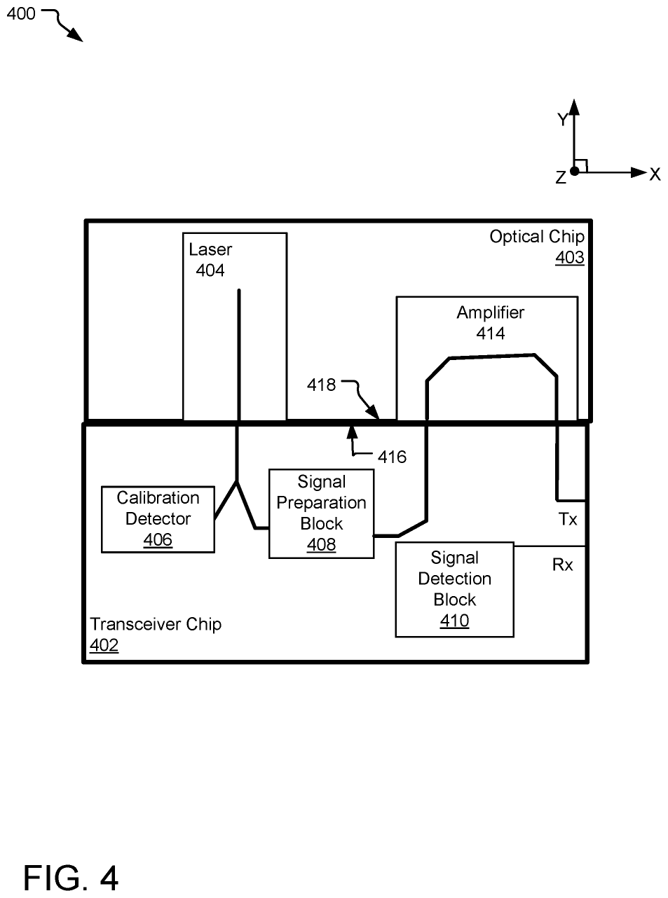

FIG. 4 illustrates an example LiDAR system 400 with a monolithically-formed optical chip (“monolithic optical chip 403”) including both a laser 404 and an optical amplifier 414. The monolithic optical chip 403 is formed in a semiconductor manufacturing process and comprises direct bandgap semiconductor materials. The monolithic optical chip 403 is attached to a monolithically-formed transceiver chip 402, which is separately formed in a semiconductor process using indirect bandgap semiconductor materials. Due to the manufacturing techniques employed, inner facing surfaces 416 and 418 are substantially planar, and the X and Z direction spacing between various components on both of the transceiver chip 402 and the monolithic optical chip 403 is substantially controlled (e.g., to within +/−50 nanometers).

The transceiver chip 402 includes the same or similar components as described elsewhere herein including a calibration detector 406, signal preparation block 408 (e.g., for modulating an outgoing light signal) and a signal detection block 410 (e.g., for mixing and processing a return signal). Likewise, the laser 404 and the optical amplifier 414 include the same or similar features as those described elsewhere herein; however, since these components are integrally formed (e.g., grown or deposited) on the monolithic optical chip 403, spacing is fixed between the laser 404 and the optical amplifier 414, further simplifying their attachment to the transceiver chip 402. In this implementation, the laser 404 is turned on and the surfaces 416 and 418 are brought toward one another to within a predefined y-distance separation. At this separation, the monolithic optical chip 403 is moved (e.g., in the X and Z directions) relative to the transceiver chip 402 (or vice versa) while monitoring intensity light striking a calibration detector and/or of a return light signal detected by signal detection block 410. Via this technique, an [X, Z] position of maximum coupling efficiency is identified and the monolithic optical chip 403 is then attached to the transceiver chip 402 at this identified position, such as by flowing solder or curing an adhesive paste at the interface between the two components.

Notably, the implementation of FIG. 4 allows alignment of all light-emitting components with the transceiver chip 402 in a single, two-dimensional calibration process.

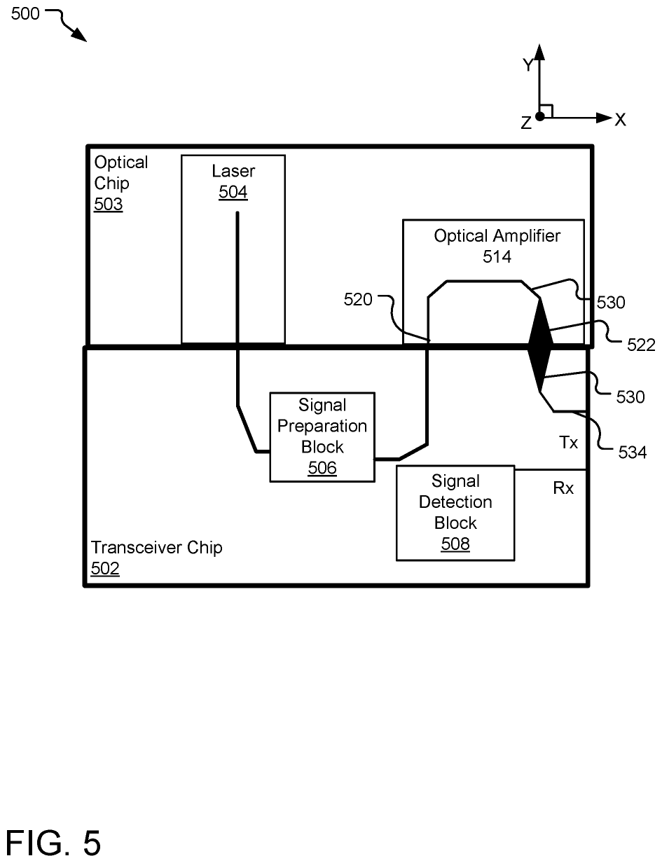

FIG. 5 illustrates components of another example LiDAR system 500 with a monolithically-formed optical chip 503 including both a laser 504 and a u-shaped optical amplifier 514 with a tapered waveguide 530. Specifically, the tapered waveguide 530 has a diameter that increases with distance away from an input 520 and toward an output 522 of the optical amplifier 514. In one implementation, the diameter 530 increases from 1-4 microns at the input 520 to a few hundred (e.g., 200) microns at the output 522. This tapering increases surface area of the gain media that contacts the light, which in turn increases power of the u-shaped optical amplifier 514. In the above example with the waveguide tapering increasing the waveguide diameter by about factor of −200 between in the input and output, power of the optical amplifier is increased by a factor of −500 to 1000 (e.g., increasing power of light output from a 10 mW laser to 5-10 W).

Like other implementations here, the LiDAR system 500 also includes a transceiver chip 502 with various hardware components, such as a signal preparation block 506 and a signal detection block 508, which may include components the same or similar to other like-named components described herein. Unlike other implementations disclosed herein, the transceiver chip 502 includes a tapered waveguide 534 that receives amplified light from the u-shaped optical amplifier 514 and directs the light down to a Tx arm 534 that projects the light onto scanning optics (not shown). The tapered waveguide 534 has a taper in a reverse direction of the taper in the u-shaped optical amplifier 514 so as to gradually concentrate the amplified light beam back down to its original diameter such that a light beam emitted from the Tx arm 534 has a diameter matching a target spot size to provide the system with a target resolution for an imaged scene.

Other aspects of the transceiver chip 502 may be the same or similar to other implementations described herein.

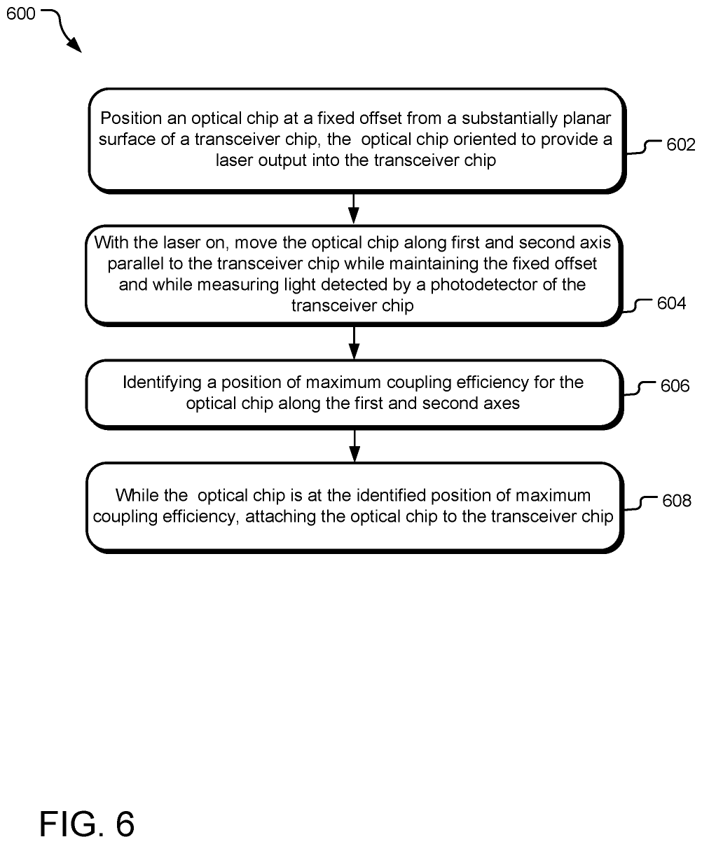

FIG. 6 illustrates example operations 600 for aligning solid state components in a LiDAR system. The LiDAR system includes a u-shaped optical amplifier and a laser formed integrally as part of a monolithic semiconductor chip referred to below as an “optical chip.” According to one implementation, the optical chip includes a first substantially planar surface designed to interface with a substantially planar surface of the transceiver chip. The substantially planar surface of the optical chip includes an output of the laser as well as an input and output to the u-shaped optical waveguide.

A positioning operation 602 positions the monolithic optical chip at a fixed offset from the transceiver chip with the laser output directed toward the transceiver chip. A calibration operation 604 moves the monolithic optical chip along first and second parallel axes relative to the transceiver chip while maintaining the fixed offset, while the laser is emitting light, and while also measuring light detected by a photodetector of the transceiver chip. In one implementation, the photodetector is a detector in a signal processing block that receives reflected light after the light has been emitted from the LiDAR system and bounced off of a target. In another implementation, the photodetector is a calibration photodetector on the transceiver chip that receives light after being emitted from the laser but before the light is amplified by the optical amplifier, such as in a configuration the same or similar to that shown in FIG. 2A-2B.

An identifying operation 606 identifies, based on photon measurements of the calibration operation, a position of maximum coupling efficiency for the monolithic optical chip along the first and second axes relative to the transceiver chip. An attachment operation 608 attaches the monolithic optical chip to the transceiver chip while the monolithic chip is at the position of maximum coupling efficiency, such as by melting solder or curing adhesive applied to an interface between the inner-facing substantially planar surfaces of the transceiver chip and the monolithic optical chip.

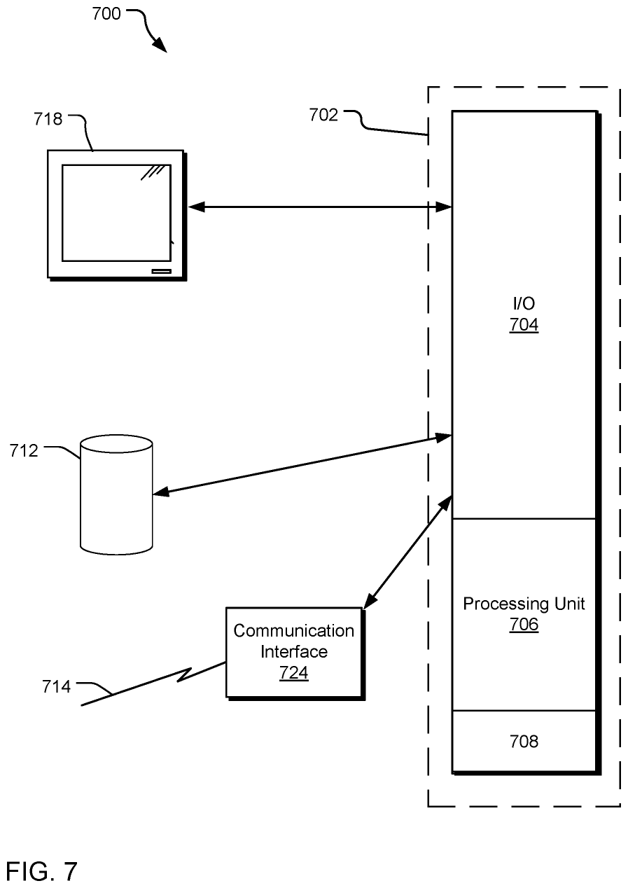

FIG. 7 illustrates an example processing system 700 that may be useful in implementing the described technology. For example, the processing system 700 may be adapted to receive and process LiDAR data. Data and program files may be input to the processing system 700, which reads the files and executes the programs therein using one or more processors. Some of the elements of a processing system 700 are shown in FIG. 7 wherein a processing device 702 is shown having an input/output (I/O) section 704, a processing unit 706, and a memory 708.

In various implementations, the processing unit 706 could be an application-specific integrated circuit (ASIC), digital signal processor (DSP), system on chip (SoC), central processing unit (CPU) of a general purpose computer, etc. In some implementations, the processing unit 706 comprises more than one processor. The processor(s) may be single core or multi-core processors. The processing device 702 may be a special purpose computing device, a conventional computer, a distributed computer, or any other type of processing device.

In some implementations, an operating system (not shown) may reside in the memory 708 and be executed by the processing unit 706. In other implementations, the processing unit 706 does not execute an operating system during nominal operations. One or more applications (not shown) may reside in the memory 708, such applications for modulating outgoing light, controlling hardware of a beam control unit to steer a light beam, signal processing applications, and/or calibration applications.

The I/O section 704 may be connected to one or more user-interface devices (e.g., a keyboard, a touch-screen display unit 718, etc.) or a storage unit 712. Computer program products containing mechanisms to effectuate the systems and methods in accordance with the described technology may reside in the memory 708 or on the storage unit 712 of the processing system 700.

A communication interface 724 may be capable of connecting the processing system 700 to a network via the network link 714, through which the computer system can receive instructions and data embodied in a carrier wave. When used in a local area networking (LAN) environment, the processing system 700 is connected (by wired connection or wirelessly) to a local network through the communication interface 724, which is one type of communications device. When used in a wide-area-networking (WAN) environment, the processing system 700 typically includes a modem, a network adapter, or any other type of communications device for establishing communications over the wide area network. In a networked environment, program modules depicted relative to the processing system 700 or portions thereof, may be stored in a remote memory storage device. It is appreciated that the network connections shown are examples of communications devices for and other means of establishing a communications link between the computers may be used.

In an example implementation, a map constructor and beam steering control instructions are stored in memory 708 and/or an external storage unit 712 and executed by the processing device 702. Further, local computing systems, remote data sources and/or services, and other associated logic represent firmware, hardware, and/or software, which may be configured to assist in supporting a LiDAR system. One or more aspects of a LiDAR system may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 708 and/or the storage unit 712 and executed by the processing unit 706.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly. Tangible processor-readable storage media exclude es intangible communications signals (such as signals per se) and includes volatile and nonvolatile, removable, and non-removable storage media implemented in any method or technology for storage of information such as processor-readable instructions, data structures, program modules, or other data.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A LiDAR system including:
a transceiver chip including a signal preparation block that modulates an outgoing light beam;
a laser attached to the transceiver chip, the laser positioned to provide an input to the signal preparation block; and
a u-shaped optical amplifier attached to the transceiver chip positioned to receive an optical signal output from the signal preparation block and to output an amplified optical signal back into the transceiver chip.

2. The LiDAR system of claim 1, wherein the laser has an output aligned with a first waveguide on the transceiver chip, the first waveguide being coupled to an input of the signal preparation block.

3. The LiDAR system of claim 1, wherein the u-shaped optical amplifier has an input positioned to receive an output from a first end of a second waveguide on the transceiver chip, the second waveguide providing the u-shaped optical amplifier with light output by the signal preparation block.

4. The LiDAR system of claim 3, wherein the u-shaped optical amplifier has an output aligned with a third waveguide on the transceiver chip, the third waveguide directing light output by the u-shaped optical amplifier to scanning optics that project the light onto a target.

5. The LiDAR system of claim 2, wherein the transceiver chip further includes a calibration photodetector and the first waveguide is further coupled to the calibration photodetector.

6. The LiDAR system of claim 1, wherein the u-shaped optical amplifier is positioned to receive an input from the transceiver chip and to provide an amplified output to the transceiver chip.

7. The LiDAR system of claim 1, wherein the transceiver chip includes a transmit arm and a receive arm, the transmit arm configured to transmit the amplified optical signal to scanning optics and the receive arm configured to receive a return signal from a detector and provide the return signal to a signal processing block on the transceiver chip.

8. A method comprising:
forming a monolithic optical chip including both a laser and an optical amplifier;
forming a transceiver chip with a signal preparation block that modulates an outgoing light beam and a photodetector;
positioning the monolithic optical chip at a fixed offset from a substantially planar surface of the transceiver chip with an output of the laser directed toward the transceiver chip;
moving the monolithic optical chip along first and second perpendicular axes that are both parallel to the substantially planar surface while maintaining the fixed offset and while measuring light detected by the photodetector;
identifying a position of maximum coupling efficiency for the monolithic optical chip, the position of maximum coupling efficiency corresponding to a highest signal measured by the photodetector for various positions of the monolithic optical chip along the first and second perpendicular axes; and
while the monolithic optical chip is at the position of maximum coupling efficiency, attaching the monolithic optical chip to the transceiver chip.

9. The method of claim 8, wherein the photodetector is a calibration photodetector of the transceiver chip that receives light output of the laser before the light is passed through the optical amplifier.

10. The method of claim 8, wherein the optical amplifier includes a u-shaped waveguide.

11. The method of claim 10, wherein the optical amplifier includes both an input and an output that interface with a same surface of the transceiver chip.

12. The method of claim 9, wherein the transceiver chip is further configured to receive a return signal detected by a detector and to provide the return signal to a signal processing block.

13. The method of claim 8, wherein the laser is, at the position of maximum coupling efficiency, positioned to direct light into a first waveguide on the transceiver chip, the first waveguide being coupled to a signal preparation block and also to a calibration photodetector.

14. The method of claim 8, wherein attaching the laser to the transceiver chip further comprises:
applying solder balls to a substantially planar surface of the monolithic optical chip prior to aligning the laser for attachment to the transceiver chip;
while the monolithic optical chip is at the position of maximum coupling efficiency with the substantially planar surface of the monolithic optical chip facing the substantially planar surface of the transceiver chip, applying heat to the solder balls.

15. The method of claim 8, wherein attaching the laser to the transceiver chip further comprises:
applying a curable paste to the substantially planar surface of the transceiver chip; and
applying at least one of heat or UV light to the curable paste to harden the paste when the monolithic optical chip is at the position of maximum coupling efficiency.

16. A LiDAR system including:
a transceiver chip including a calibration photodetector and a signal preparation block configured to modulate an outgoing light beam;
a laser attached to the transceiver chip, the laser positioned to provide an input to a first waveguide coupled to both the signal preparation block and to the calibration photodetector; and
a u-shaped optical amplifier attached to the transceiver chip and positioned with a first end to receive a signal output from the signal preparation block and to provide an amplified signal back into a second waveguide of the transceiver chip.

17. The LiDAR system of claim 16, wherein the transceiver chip includes a transmit arm and a receive arm, the transmit arm configured to receive the amplified signal from the second waveguide and to transmit the amplified signal to scanning optics that project the amplified signal onto a target.

18. The LiDAR system of claim 16, wherein the transceiver chip further includes a receive arm configured to receive a return signal detected by a detector and to provide the return signal to a signal processing block on the transceiver chip.

19. The LiDAR system of claim 16, wherein interfacing surfaces of the transceiver chip, the u-shaped optical amplifier, and the laser are all substantially planar.

20. The LIDAR system of claim 16, wherein the laser and the u-shaped optical amplifier are both included in a monolithically formed optical chip.
